(19) United States
(12) Patent Application Publication
(10) Pub. No.: US 2024/0409402 A1
(43) Pub. Date: Dec. 12, 2024

(54) Method, Apparatus and Carrier Materials for Upcycling Sulfurous and/or Oxidic Streams to Hydrogen and/or Nitrous Streams

(71) Applicant: Adrian Cesar Cavazos Sepulveda, San Pedro Garza Garcia (MX)

(72) Inventor: Adrian Cesar Cavazos Sepulveda, San Pedro Garza Garcia (MX)

(21) Appl. No.: 18/812,917

(22) Filed: Aug. 22, 2024

(51) Int. Cl. C01B 3/06; C01C 1/04

(52) U.S. Cl. CPC C01B 3/06; C01C 1/04; C01B 2203/068; C01B 2203/10

(57) ABSTRACT

Sulfurous streams are considered of negative or nil value and thus are required to be processed. Herein methods, apparatus, and materials are disclosed to upcycle a sulfurous streams to nitrous streams with the use of a carrier materials with a variable stoichiometry comprised of sulfoxynitride species and energy stimuli. An example of an effluent nitrous stream includes ammonia. Further methods disclose how to upcycle an abundant nitrous stream to a subsequent nitrous stream such as nitrous oxides with the help of a carrier material and an ionic conductor.

### FIELD OF THE DISCLOSURE

This disclosure pertains to the conversion of hydrogen containing species from sulfurous and/or oxidic species to nitrous species through thermal processes or thermal processes enhanced with at least one of the following: catalyst, superimposed non-thermal energy inputs, alternating input streams or combining input streams.

### BACKGROUND OF THE INVENTION

Ammonia is an essential precursor for the production of a plurality of products including fertilizers. As such it is estimated that about 1.9% of the energy produced around the world is destined for its production. The industrially used process for the synthesis of ammonia is the energy intensive Haber-Bosch process. Furthermore ammonia is considered as viable energy vector within a decarbonized hydrogen economy due to its higher volumetric density relative to molecular hydrogen.

The Haber-Bosch process converts hydrogen and nitrogen to ammonia by utilizing high temperatures and pressures. While the nitrogen is purified from air though diverse separation processes, hydrogen is industrially derived from atomic hydrogen containing feed-stocks. The current primary hydrogen source involves the conversion of carbonous species, such as methane (a potent green house gas). While newer methods involve decarbonized sources, revolving around the hydrolysis of oxidic species, such as water.

Moreover, it is estimated that about 70% of the produced ammonia is utilized in the production of fertilizers, such as ammonium nitrate. An intermediate step in the formation of ammonium nitrate is the ammonia oxidation to nitric acid through the Ostwald process. That nitric acid is then reacted with a subsequent ammonia molecule to form the ammonium nitrate. In other words the production of an ammonium nitrate molecule utilizes at least two ammonia molecules. Other fertilizers such as urea have similar ammonia requirements

Sulfurous species, such as for a non-limiting example of hydrogen sulfide (H₂S), is an ubiquitously available toxic and corrosive gas, which is commonly associated to the co-production of hydrocarbons. That being said H₂S is also co-produced from renewable biological processes. Industrially, H₂S is handled through the Claus process, where a H₂S containing stream is combusted to produce SOₓ and subsequently it is reacted to produce low-value commodities such as elemental sulfur and water.

### SUMMARY OF THE INVENTION

An excerpt is provided of various concepts presented within this disclosure in order to facilitate a general understanding. The summary is not intended to identify key or essential features of the claimed subject matter, nor it is intended as an aid in limiting the scope of the claimed subject matter. Further aspects, details, advantages, and improvements on the subject mater will be described hereinafter to a greater extent.

A first non-limiting example method of the present disclosure may include: supplying a first sulfurous stream (e.g. comprising at least partially H₂S) to a first (anion) carrier material, wherein the first anion carrier comprises sulfoxynitride species, namely an anion carrier material (including composite (anion) carrier material) comprising anions of sulfur, oxygen, nitrogen, or traces thereof, within a plurality of stoichiometric or non-stoichiometric ratios. Contacting the first sulfurous stream with the first (anion) carrier to produce a first nitrous stream, including but not limited to ammonia, N₂O, NO, NO₂, NO₃, nitric acid, cyanamide, thiourea, urea, ammonium nitrate, the like, and a second (anion) carrier. The embodiment further including an optional regeneration step where at least one of the following: an effluent second sulfurous stream is produced, including but not limited to liquid or gaseous sulfur and contacting the second (anion) carrier with a nitrogen containing stream in order to regenerate approximately the second (anion) carrier stoichiometry to that of the first (anion) carrier material.

A second non-limiting example method of the present disclosure may include: supplying concomitantly or sequentially, in no particular order, number of steps, or iterations, at least one of the following: a first sulfurous stream, a first oxidic stream, wherein the first oxidic stream might include but is not limited to water, hydrogen peroxide, oxygen, ozone, CO, and CO₂; and mixtures thereof, to a first (anion) carrier material, wherein the first (anion) carrier comprises sulfoxynitride species, namely a (anion) carrier material (including a composite anion carrier material, catalyst, catalyst support) comprising anions of sulfur, oxygen, nitrogen or traces thereof, within a plurality of stoichiometric or non-stoichiometric ratios. Contacting the first sulfurous stream with the first (anion) carrier to produce a first nitrous stream, including but not limited to at least one of the following: ammonia, nitric acid, N₂O, NO, NO₂, NO₃, cyanamide, thiourea, urea, and ammonium nitrate as well as a second (anion) carrier. The embodiment further including at least one optional regeneration step where at least one of the following: an effluent second sulfurous stream is produced, including but not limited to liquid or gaseous sulfur, contacting the second (anion) carrier with a second sulfurous stream, contacting the second (anion) carrier with a second oxidic stream, and contacting the second (anion) carrier with a nitrogen containing stream, and a mixture thereof in order to approximately regenerate the second (anion) carrier's stoichiometry to that of the first (anion) carrier.

A third non-limiting example system of the present disclosure may include: a reaction chamber (enclosure), a first (anion) carrier material within the reaction chamber, supplying concomitantly or sequentially, in no particular order, number of steps, or iterations, at least one of the following: a first sulfurous stream, a first oxidic stream, wherein the first oxidic stream might include but is not limited to water, hydrogen peroxide, oxygen, ozone, CO, and CO₂; a nitrous stream, and mixtures thereof, to a first (anion) carrier material, wherein the first (anion) carrier comprises sulfoxynitride species, namely a (anion) carrier material (including composite anion carrier material) comprising anions of sulfur, oxygen, nitrogen or traces thereof, within a plurality of stoichiometric or non-stoichiometric ratios. Contacting the first sulfurous stream with the first (anion) carrier to produce a first nitrous stream, including but not limited to at least one of the following: ammonia, nitric acid, N₂O, NO, NO₂, NO₃, cyanamide, thiourea, urea, and ammonium nitrate as well as a second (anion) carrier. The embodiment further including an optional regeneration step where at least one of the following: an effluent second sulfurous stream is produced, including but not limited to liquid or gaseous sulfur, contacting the second (anion) carrier with a second sulfurous stream, contacting the second (anion) carrier with a second oxidic stream, contacting the second (anion) carrier with a nitrogen containing stream, and a mixture thereof in order to approximately regenerate the second (anion)'s stoichiometry to that of the first (anion) carrier.

In a further non-limiting embodiment, a mode of operation wherein an anion carrier is subjected to at least one or more of the following: a stimulus and/or a stream being of at least one of the following: oxidic, nitrous, sulfurous, reducing (e.g. including hydrogen), inert and a combination thereof in order to mobilize species (e.g. atomic, such as ionic or neutral; molecular; and combination thereof) from, to, or a combination thereof to the interface and producing an interfacial layer and a modified carrier with the purpose of making at least one atomic species available to at least one of the following: react with a other species (as in the non-limiting example of mobilizing lithium, magnesium, manganese, to name a few, to react with nitrogen and/or oxygen, such as Li in Li_{α}Na_{β}Nₓ, to facilitate nitrogen reactivity with oxygen), phase change (as in the non-limiting example of removing Li from LiSₓ to facilitate sulfur evaporation), dissolve, desorb (as in the non-limiting example of oxygen or sulfur desorption). The atomic species mobilization include but are not limited to the creation, formation, destruction, occupation, the like, and combinations thereof of at least one of the following: interfacial layer, interstitial sites, particles, alloys, composites, compound, stoichiometric variations of a carrier material, stoichiometric variations of a catalytic material, phase segregations, the like, and combinations thereof. Further providing a stimulus and optionally an input stream to produce an effluent stream (as in the non-limiting example of sulfur, oxygen, NOₓ, ammonia, nitric acid, ammonium nitrate, the like and combinations thereof) and a further carrier. Subjecting the carrier to a subsequent stimulus (e.g. as in the non-limiting step of regeneration) and an input stream to mobilize an atomic species to, from, or a combination thereof the interface and producing an interfacial layer and a modified carrier with the purpose of making at least one atomic species available to at least one of the following: react with another species, phase change dissolve, absorb, adsorb, catalyse, and combinations thereof producing an carrier. Results of the atomic species mobilization include but are not limited to the creation, formation, destruction, occupation, and combinations thereof of at least one of the following: interfacial layer, interstitial sites, particles, composites, compounds, stoichiometric variations of a material, phase segregations, and combinations thereof.

### BRIEF DESCRIPTION OF DRAWINGS

FIG. 1 is a diagram of a non-limiting example method according to the present disclosure.

FIG. 2 is a diagram of a non-limiting example method according to the present disclosure.

FIG. 3 is a diagram of a non-limiting example method according to the present disclosure.

FIG. 4 is a schematic representation of a non-limiting example method according to the present disclosure.

FIG. 5 is an illustration of a non-limiting example of a device according to the present disclosure.

### DETAILED DESCRIPTION OF THE INVENTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that embodiments disclosed herein may be practiced without these specific details. In other instances, well-known features have not been described in detail to avoid unnecessarily complicating the description. Additionally, it will be apparent to one of skill in the art that the scale of the elements presented in the accompanying Figures may vary without departing from the scope of the present disclosure. Variations can include yet are not limited to at least one of the following: process step reordering, step repetition, steps omission, steps merging and combinations thereof.

Embodiments of this disclosure relate to the need to develop sustainable, clean, and efficient methods for the production and conversion of energy vectors and chemicals within the scope of the hydrogen economy. Hydrogen sulfide (H₂S) is an abundant health hazardous and reactive gas. This gas is conventionally considered as an industrial burden with negative economic value, yet it poses unique advantages for the hydrogen economy as a low energetic source for H₂ production.

The Claus process is the currently widespread mature method for handling H₂S within a relevant industrial environment. This method is hosted within sulfur recovery units where H₂S (and CO₂) is concentrated from a hydrocarbon stream, conventionally through an amine stripping process. The concentrated H₂S is mixed with an oxygen containing stream and in some cases with gaseous hydrocarbons. The mixture is combusted to produce SOₓ, water, CO₂. Subsequently that feed is further reacted with H₂S to produce sulfur, water alongsides of CO₂, traces of H₂S and other gases from the oxygen containing stream. Sulfur is separated and the tail gases are either further processed or released to the atmosphere.

Hydrogen is considered as the up and coming energy vector. The current primary source for hydrogen production is through the reformation of fossil fuels such as methane (CH₄). Widely available reformation methods have a relative high carbon emission footprint when the produced CO₂ is not captured and sequestered. As an alternative, water electrolysis is posed as a low-carbon hydrogen production method, particularly when the energy is derived from renewable energy sources. That being said through a simple energetic analysis and considering no CO₂ emissions, the absolute best-case scenario for producing hydrogen from water and methane would entail, 273 KJ/mol and 50 KJ/mol (yielding 2 mol H₂), respectively. Comparatively H₂O requires about an energetic input of about an order of magnitude higher. Other factors to consider include water purification, desalinisation and overpotentials which are employed by current industrial electrolysis devices.

Advantages in this disclosure relate to the energetics of considering H₂S as well as H₂S and H₂O as the hydrogen source. In the best case scenario H₂S would require 33 KJ/mol. Furthermore the reactivity of H₂S rather than a drawback could be considered an advantage for diverse conversion methods. Previous ammonia producing methods employing carrier or looping materials for temporarily fixing atomic nitrogen within their structure and subsequently reacting them with H₂ or H₂O to produce ammonia. Within the scope of this disclosure it is included the production of nitrogen containing species (e.g. ammonia, nitric acid, N₂O, NO, NO₂, NO₃, cyanamide, thiourea, urea, ammonium nitrate and extending to hydrogen), from a sulfurous stream (e.g. containing atomic sulfur species such as at least one of the following: H₂S, sulfur, SO, SO₂, SO₃, and a combination thereof, with of at least one of the following: nitrogen, hydrogen, carbon monoxide, carbon dioxide, methane, ethane, propane, butane, pentane, hexane, pentane, noble gas, and a mixture thereof) and optionally an oxidic stream (e.g. H₂O, O₂, H₂O₂, O₃, CO, and CO₂) utilizing sulfoxynitride species. Furthermore prior art in carrier materials for H₂S conversion to hydrogen are restricted primarily to single cationic and anionic species such as for the production of hydrogen. This disclosure relates to methods leveraging multi-ionic (multi-anionic) carrier species on carrier support materials based on ionic conductors, wherein hereinafter ionic conductors further comprises ionic and electronic (e.g. mixed) conductive materials, as well as further composites including catalysts (e.g. metals) and catalyst supports, hereinafter comprehensively referred to as an anion carrier.

Additional improvements within the scope of this disclosure include production of nitrous species with a thermal input, wherein temperature ranges between −20° C. to 1100° C., in synergy with orthogonal energy stimuli enabling at least one of the following advantages: a wider-scope of available materials, improved overall required thermal input, operation within a narrower temperature range, and enhanced throughput (kinetics). Appraised energy stimuli orthogonal to thermal energy include at least one of the following stimuli: electric (e.g. potential, field, current the aforementioned applied in at least one of the following constantly, variable, alternating in high or low frequencies and a combination thereof), chemical (e.g. partial pressure changes, alternating between sulfurous & oxidic streams, mixing sulfurous & oxidic streams), magnetic, photonic (e.g. direct absorption, indirect absorption, plasmonic), plasma, ultrasonic, chemical (e.g. variations in the partial pressure of species surrounding the carrier), overall pressure or a combination thereof (e.g. including: photo-electrical, electrochemical, photo-chemical and photo-electrochemical), hereinafter comprehensively or individually referred to indistinguishably stimuli or state.

### Methods

In one aspect, the embodiments herein relate to a system for processing a sulfurous stream reacted with an anion carrier material, and optionally a composite anion carrier material composed of at least one of the following anion carrier material support, a catalyst, a catalyst support, and a combination thereof, at a given state to produce a nitrous stream or hydrogen stream. Such embodiments relate to steps or procedures which could be conducted concomitantly, sequentially, in another order, in one or more reactors as well as skipping, merging or adding steps or procedures without deviating from the present disclosure.

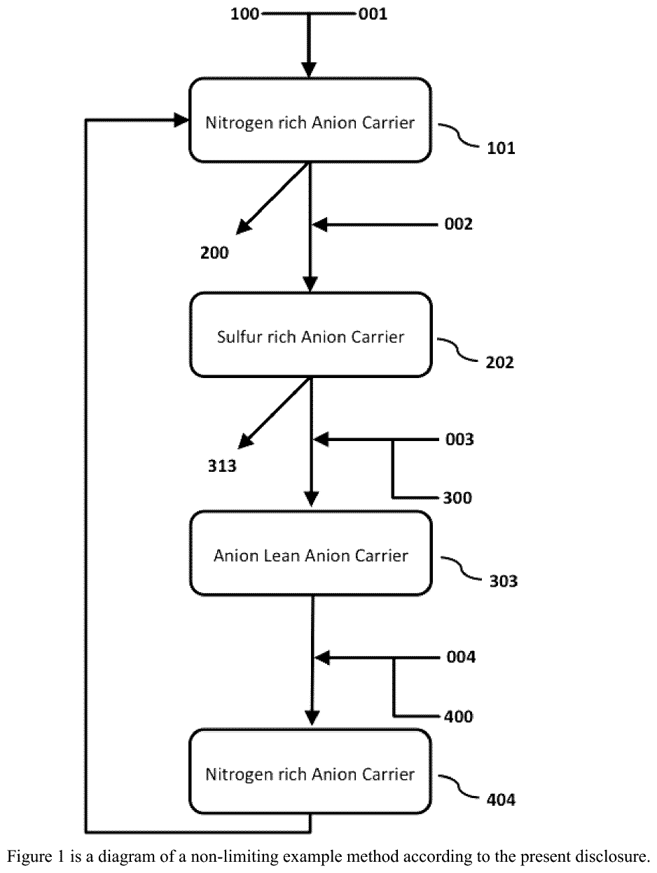

In a non-limiting embodiment, a mode of operation is illustrated as in FIG. 1, herein relate to a system for processing a sulfurous stream 100 at a given state 001 provided to a nitrogen rich anion carrier material 101, in one or multiple reactors. Further producing a nitrous stream 200 and a sulfur rich anion carrier 202 by a given stimuli 002. A sulfur rich anion carrier 202 further being taken to a state 003 and optionally providing at least one of the following: an inert stream, vacuum, a reducing atmosphere and a combination thereof 300 to produce an anion lean anion carrier 303 and a sulfurous stream 313. Further reacting an anion lean anion carrier at a state 004 with a nitrous stream 400 to produce a nitrogen rich anion carrier 404, which may be approximately in composition to 101, and optionally repeating the cycle. In particular at least of the following steps related to 101 & 202; 202 & 303; and 303 & 404 could be conducted conjointly.

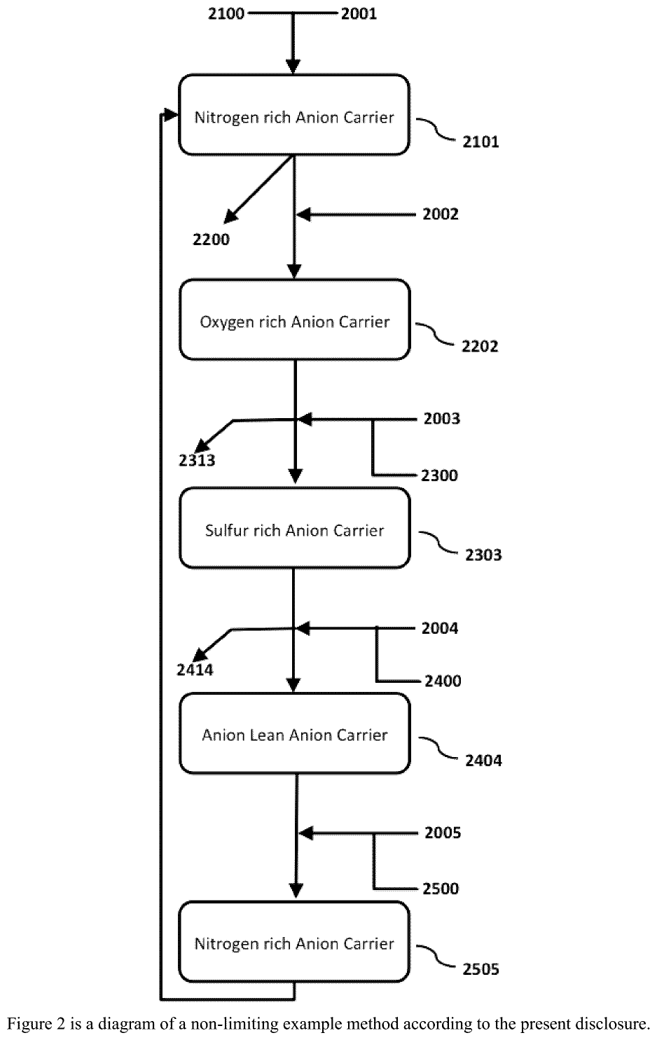

In a non-limiting embodiment, a mode of operation is illustrated as in FIG. 2, herein relate to a system for processing a oxidic stream 2100 which is being provided to a nitrogen rich anion carrier material 2101, at a given state 2001, in one or multiple reactors. Further produce a nitrous stream 2200 and an oxygen rich anion carrier 2202 by a stimuli 2002. Providing a sulfurous stream 2300 to an oxide rich anion carrier 2202 and reacting it at a state 2003 to produce a sulfur rich anion carrier 2303 and a sulfurous and/or hydrogen containing stream 2313. A sulfur rich anion carrier 2303 being provided a stimuli 2004 and optionally provide at least one of the following: an inert stream, vacuum, a reducing atmosphere, and a combination thereof 2400 to produce a anion lean anion carrier 2404 and a sulfurous stream 2414. Further reacting a anion lean anion carrier 2404 with a nitrous stream 2500 at a state 2005 to produce a nitrogen rich anion carrier 2505, which may be approximately in composition to 2101, and optionally repeating the cycle. In particular steps related to 2101 & 2202; 2202 & 2303; and 2303, 2404, and 2505 could be conducted conjointly.

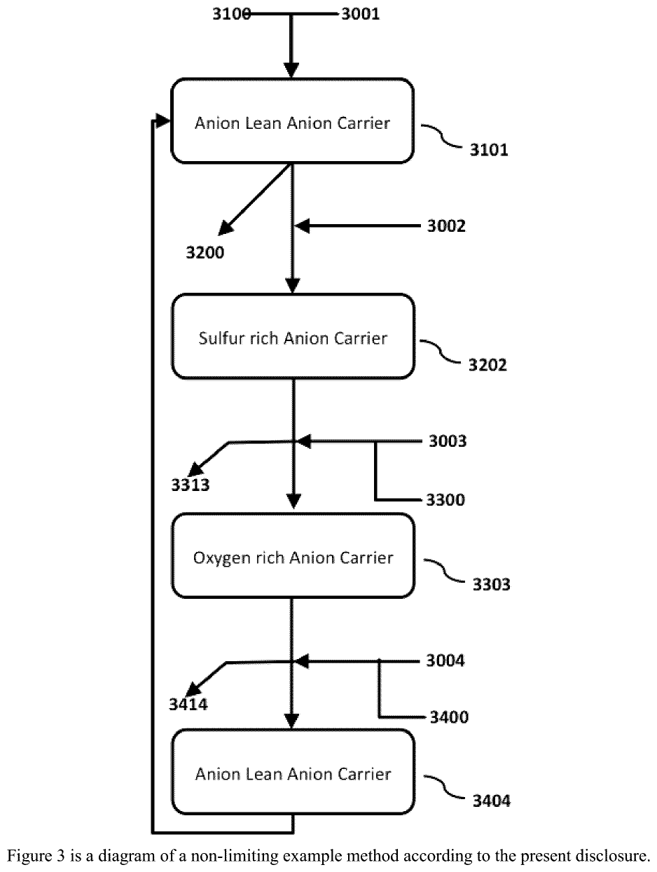

In a non-limiting embodiment, a mode of operation is illustrated as in FIG. 3, herein relate to a system for processing a sulfurous stream 3100 provided to an anion lean anion carrier material 3101, at a given state 3001, in one or multiple reactors. Producing a hydrogen containing stream 3200 and a sulfur rich anion carrier 3202 with a given stimuli 3002. Providing an oxidic stream 3300 to a sulfur rich anion carrier 3202 and reacting it at a state 3003 to produce a oxygen rich anion carrier 3303 and a sulfurous and/or hydrogen containing stream 3313. An oxygen rich anion carrier 3303 being provided a stimuli 3004 and optionally provide at least one of the following: an oxidic, an inert stream, vacuum, a reducing atmosphere, and a combination thereof 3400 to produce an anion lean anion carrier 3404 and an oxidic stream 3414, wherein 3404 may be approximately in composition to 3101, and optionally repeating the cycle. Optionally, steps for introducing nitrogen species could be included. In particular steps related to: 3101 & 3202 and 3303 & 3404; could be conducted conjointly. As a non-limiting example materials which could be included within this embodiment include at least one of the following: Au, Ag, Pt, Rh, Ir and Re and optionally alloying them with at least one of the following: Li, Mn, Mg, Ca, Zn, Na, and combinations thereof, and optionally further supporting them on an ionic conductor.

From the previous embodiments it would be obvious to those skilled in the art that further permutations and step insertions could be conceived such as a further nitrogenizing step between a sulfur rich anion carrier and an oxygen rich anion carrier, multistep regeneration such as to include at least one of the following: absorption, transport, dissolution, incorporation, diffuse (e.g. including to the surface, to the interface, interstitial sites, to name a few), exsolve, intercalate, desorb and a combination thereof of atomic species (cationic, anionic or neutral) into, to and/or from the anion carrier material (composite, anion carrier support, catalyst, catalyst support).

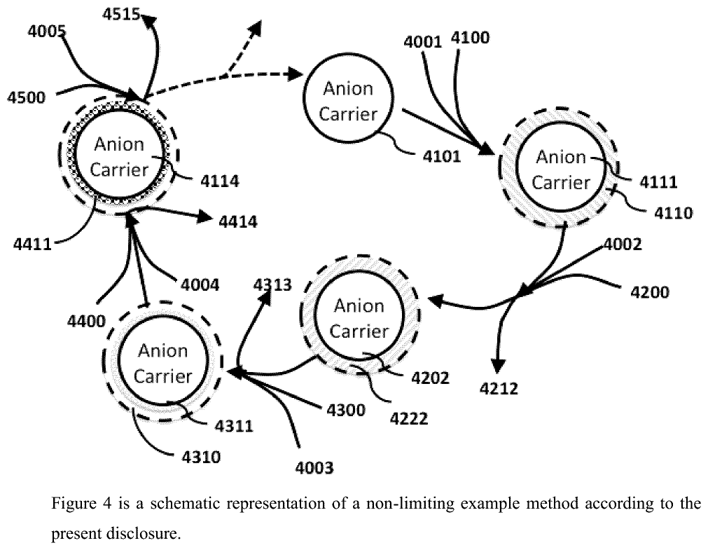

In a non-limiting embodiment, a mode of operation and/or regeneration is illustrated in FIG. 4, wherein an anion carrier 4101 is subjected to a stimulus 4001 and/or a stream 4100 being of at least one of the following: oxidic, nitrous, sulfurous, reducing (e.g. including hydrogen), inert and a combination thereof in order to mobilize species (e.g. atomic, such as ionic or neutral; molecular; and combination thereof) to, from, or a combination thereof the interface and producing an interfacial layer 4110 and a modified anion carrier 4111 with the purpose of making at least one atomic species available to at least one of the following: react with another species (as in the non-limiting examples of mobilizing lithium, sodium, potassium, magnesium, calcium and/or potentially manganese, to name a few, to react with nitrogen and/or oxygen), phase change (as in the non-limiting example of sulfur evaporation), dissolve, desorb (as in the non-limiting example of oxidic or sulfurous species desorption), catalyse a subsequent reaction (as in the non-limiting example of mobilizing Li to Li_{α}Mn_{β}Nₓ to make it susceptible for subsequent reactions e.g. with nitrogen, sulfur, oxygen, and/or ozone). Results of the atomic species mobilization include but are not limited to the creation, formation, destruction, occupation and combinations thereof of at least one of the following: interfacial layer, interstitial sites, particle, composites, compound, stoichiometric variations of a carrier material, phase segregations and combinations thereof. Further subjecting 4110 and/or 4111 to a stimulus 4002 and optionally to an input stream 4200 to produce an effluent stream 4212 stream (as in the non-limiting example of ammonia, hydrogen, sulfur, oxygen, NOₓ, nitric acid, ammonium nitrate, urea, thiourea, the like, and combinations thereof) and an anion carrier 4202 with an interfacial layer 4222. Subjecting the anion carrier 4202 to a stimulus 4003 and an optional input stream 4300 to mobilize an atomic species to, from, or a combination thereof the interface and producing an interfacial layer 4310, an optional effluent stream 4313, and a modified anion carrier 4311 with the purpose of making at least one atomic species available to at least one of the following: react with another species (as in the non-limiting example of mobilizing atomic or molecular species of Li, Mg, Mn, Zn, Na, Ni, Cu, O, OH⁻, Au, Pt, Ag, to name a few and react with at least one of the following stream 4400: nitrous, sulfurous, oxidic, and/or combinations thereof at an optional state 4004), phase change (as in the non-limiting example of sulfur evaporation), dissolve, absorb, adsorb (as in the non-limiting example of nitrogen adsorption), catalyse a reaction, and combinations thereof producing an anion carrier 4114, an interfacial layer 4411 and an optional effluent stream 4414. Results of the atomic species mobilization include but are not limited to the creation, formation, destruction, occupation and combinations thereof of at least one of the following: interfacial layer, interstitial sites, particles, composites, compounds, voids, stoichiometric variations of a material, phase segregations and combinations thereof. Furthermore anion carrier 4114 can be further subjected to a stimulus 4005 and an input stream 4500 (e.g. nitrous, oxidic, and/or combinations thereof), to produce an effluent stream 4515. The anion carrier 4515 or this embodiment may be optionally further processed or incorporated within the workflows of previous embodiments.

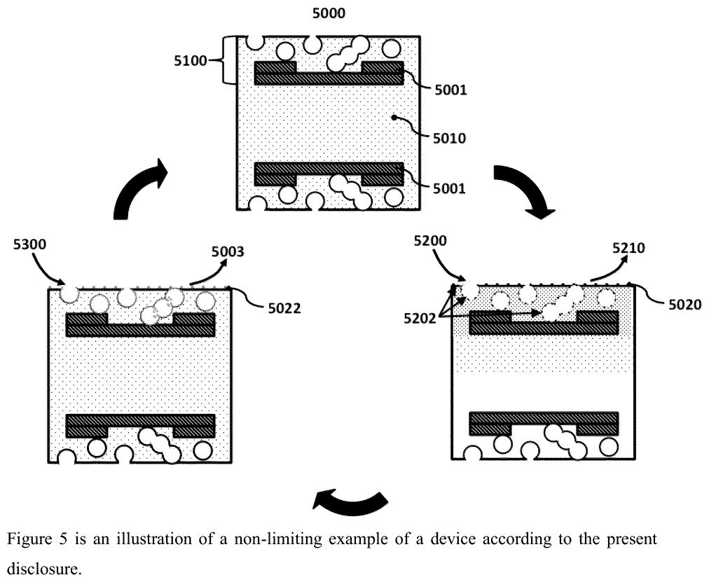

As an non-limiting embodiment of a device 5000 (illustrated in FIG. 5) comprised of at least an anion carrier material, wherein the device is further comprised with at least one or two electrodes 5001, and such electrodes are optionally comprised by at least one of the following: a metal, a carbon allotrope (e.g. graphene, graphite, fullerene, to name a few), a ceramic (including but not limited to nitrides, sulphides, oxides, phosphides, the like and combinations thereof), a glass, a fluid (e.g. electrolyte, liquid salt, ionic liquid, molten metal, deep eutectic solvent, to name a few) and a combination thereof in a plurality of potential configurations (e.g. including but not limited to wire, mesh, layer, slab, percolating network, to name a few). Wherein the device is applied an electrical potential (e.g. between −15 V to 15 V, direct potential, alternating potential (e.g. between low frequency 0.001 Hz and high frequency 1000 PHz), pulsed potential, the like, and a combination thereof and an optional further stimuli (including but not limited to at least one of the following: thermal, photonic, mechanical, plasmonic) and thus create an electrochemical potential in order to drive at least an atomic specie 5010 (e.g. including one of the following: Li, Mg, Mn, Na, K, as well as oxygen, sulfur, or nitrogen, to name a few) to an interfacial and/or superficial layer 5202. Optionally the device could include at least one porous anion carrier layer 5100. The device facilitating the interfacial and/or superficial atomic species 5010 to be reacted with at least one input stream 5200 comprised of at least one of the following: oxidic, nitrous, sulfurous, and a combination thereof to produce a nitrous or hydrogen-containing stream to produce an interfacial and/or superficial species 5020. The device being applied a further electrical potential to selectively move an atomic specie to at least one of the following: the bulk of the anion carrier material, a distinct interface location, a distinct surface location, wherein an atomic species removal from the surface and/or interface to produce species 5022, which is facilitated to forming an effluent stream 5003 with an optional input stream 5300.

As a non-limiting embodiment of an anion carrier material could comprise of a structure including at least one of the following structures: fluorite, perovskite, cubic, double perovskite, spinel, ruddlesen-popper, cubic, tetragonal, orthorombic, amorphous, monoclinic, triclinic, a defective structure thereof, inverse structure thereof, and combinations thereof. Furthermore the anion carrier comprised of at least one of the following: Li, Mn, Mg, Ca, Ce, Bi, Zr, Al, V, Zn, Co, Cu, Ni, In. Non-limiting examples of envisioned anion carriers or composite anion carriers comprising an overall composition of: Ce_{α}Mn_{β}OₓS_{y}N_{z}, Ce_{α}Au_{β}OₓS_{y}N_{z}, Ce_{α}Pt_{β}OₓS_{y}N_{z}, Ce_{α}Li_{β}OₓS_{y}N_{z}, Ce_{α}Li_{β}Mn_{γ}OₓS_{y}N_{z}, Ce_{α}Li_{β}Mn_{γ}Bi_{δ}OₓS_{y}N_{z}, Ce_{α}Li_{β}Mn_{γ}Bi_{δ}Au_{ε}OₓS_{y}N_{z}, Ce_{α}Li_{β}Mn_{γ}Bi_{δ}Pt_{ε}OₓS_{y}N_{z}, Ce_{α}Li_{β}Mn_{γ}Bi_{δ}Ag_{ε}OₓS_{y}N_{z} the aforementioned doped with Gd or Sm, LiOₓS_{y}N_{z}, Li_{α}P_{β}OₓS_{y}N_{z}, Li_{α}Ge_{β}P_{γ}OₓS_{y}N_{z}, Li_{α}Si_{β}P_{γ}OₓS_{y}N_{z}, Li_{α}Si_{β}P_{γ}A_{δ}OₓS_{y}N_{z}, Li_{α}La_{β}Zr_{γ}OₓS_{y}N_{z}, Li_{α}La_{β}Ce_{γ}OₓS_{y}N_{z}, Li_{α}Ce_{β}P_{γ}OₓS_{y}N_{z}, CaOₓS_{y}N_{z}, AgLiOₓS_{y}Nₓ, MnOₓS_{y}N_{z}, MgOₓS_{y}N_{z}, ZnOₓS_{y}N_{z}, Li_{α}Y_{β}Zr_{γ}OₓS_{y}N_{z}, Mn_{α}Y_{β}Zr_{γ}OₓS_{y}N_{z}, Mg_{α}Y_{β}Zr_{γ}OₓS_{y}N_{z}, Ca_{α}Y_{β}Zr_{γ}OₓS_{y}N_{z}, Li_{α}V_{β}OₓS_{y}N_{z}, La_{α}Sr_{β}V_{γ}OₓS_{y}N_{z}, Gd_{α}Ti_{β}Mo_{γ}OₓS_{y}N_{z}, Bi_{α}Me_{β}V_{γ}OₓS_{y}N_{z}, Dy_{α}Gd_{β}Bi_{γ}Li_{δ}OₓS_{y}N_{z}, Dy_{α}Gd_{β}Bi_{γ}Mn_{δ}OₓS_{y}N_{z}, Dy_{α}Gd_{β}Bi_{γ}Mg_{δ}OₓS_{y}N_{z}, Dy_{α}Gd_{β}Bi_{γ}Ca_{δ}OₓS_{y}N_{z}, BaZrYOₓS_{y}N_{z}, BaCeYOₓS_{y}N_{z}, Me, Me exsolutions, MeOₓS_{y}N_{z} exsolutions, solutions thereof, the aforementioned graphene coated, the aforementioned graphene encapsulated, and combinations thereof wherein α+β+γ+δ+ε=1 and x+y+3/2z ranges between 0.00 and 3, Me is comprised of at least one of the following: a transition metal (e.g. including but not limited to: Mn, Au, Ag, Rh, Ir, Re), Li, Ca, Mg, Sr, Ba, Na, K, a lanthanide (e.g. including but not limited to: Ce, Sm, Dy, Er, La, Pr, to name a few), or combinations thereof, and A is a halide.

As a non-limiting introductory embodiment, a lithium rich Li_{10+α}GeP₂OₓS_{12-x-z}N_{z} (LGPS(ON)) material with an optional doping of at least one of the following: oxygen, nitrogen, nitrogen-oxygen could be considered. A device of the aforementioned material further comprised of an electrode composed of graphene/graphite encapsulated NiCo, is taken to a temperature between −20° C. and 400° C. (not being bound by theory and/or experiments one could extrapolate the temperature range between 100° C. and 700° C.) and applied an electrical potential of about 6 volts. Lithium migrates towards the anion carrier interface creating an interfacial layer. The lithium reacting with a nitrogen containing stream to form interfacial lithium nitride. The benefits of exsolving interfacial (superficial) lithium from a carrier material is that it tends to form nanoparticles, which reduces the temperature at which they can react with nitrogen and/or melt. Reacting that interfacial lithium nitride with hydrogen sulfide to form ammonia and interfacial lithium sulfide, lithium thionitride or a combination thereof. A further electrical potential of about −10 volts being applied as to reabsorb the lithium into the LGPS(ON) matrix, while sulfur remains at the interface. Removing that sulfur through evaporation or liquefaction with or without a carrier gas stream e.g. at temperatures of about 150° C. and above, thus regenerating at least partially the anion carrier material.

As a non-limiting introductory embodiment, a (exsolved) platinum, palladium, or gold nanoparticle on a doped strontium titanate support. The nanoparticles being reacted with hydrogen sulfide to form hydrogen and a sulfidized nanoparticle. Furthermore the sulfidized nanoparticle being reacted with a water containing stream or an oxidic stream to produce a sulfurous stream, an oxidized nanoparticle and/or a metallic nanoparticle. Raising the temperature of the anion carrier to regenerate the nanoparticles (e.g. palladium above 900° C.), which could optionally be performed conjointly or independently through a photonic stimulus, electric stimulus, or a combination thereof (e.g. using platinum).

A further non-limiting introductory embodiment, where a Li, Mn, and/or Mg doped ceria, reduced ceria (including Sm and Gd dopped ceria and/or cerium OₓS_{y}N_{z}) or MoOₓS_{y}N_{z} (e.g. molybdenum sulfide, MoSₓ, where x=1-2). The cerium based anion carrier material is heated (e.g. below 950° C.) in a reducing atmosphere to exsolve the Li, Mn, Mg, Zn, with or without an electrical potential. Further the anion carrier is held under a nitrogen atmosphere to nitrogenize the particles at subsequent state temperature (e.g. a lower temperature of about 300° C. for Li) with an optional electric potential, subsequently a hydrogen sulfide stream is provided generating ammonia and a sulfidized nanoparticle. After which the nanoparticle can be subjected to an electrical potential and/or an oxidic stream to reabsorb the exsolved cations into the matrix. Other co-exsolvable materials include Ag, Ni, In, Ir, Cu, V, and alloys made thereof with the former exsolvable materials. Alternative matrix materials for exsolution include other ionic conductors such as those from the BiMeVOx ionic conductor family.

A further non-limiting embodiment relates to the oxidation of nitrogen rich anion carrier to produce at least one of the following: N₂O, HNO, H₂N₂O₂, cyanamide, thiourea, urea, NO₁₊ₓ, HNO₂₊ₓ, where x ranges between 0 and 1. An additional embodiment route includes the reabsorption of an exsolved species. A non-limiting example includes the dealloying (delithiation) of an (AgₓLi_{y}Na_{z})₃N particle and its subsequent oxidation in the presence of a catalyst (e.g. including but not limited to: Cu, Ni, Ta, Nb, Nd, Mn, V, La, Ni, Co, Ti, Zr their sulphides, their oxides such as LaCo_{0.75}Mn_{0.125}Ni_{0.125}O₃₋ₓ, their nitrides such as TiN, ZrN, VN their oxynitrides such as plasmonic TiNₓO_{y}, ZrNₓO_{y} and VNₓO_{y}, to name a few) alternative materials for such process could include other battery type of materials such as those for at least one of the following: Mg-ion, Mn-ion, Na-ion, K-ion and combinations thereof. (e.g. mixed ion conductors such as Li and Na such as Li_{α}Si_{β}Ge_{γ}P_{δ}OₓS_{y}N_{z}Cl_{w}, Li_{α}Na_{(1-α)}Sr_{β}Zr_{γ}P_{δ}OₓS_{y}N_{z}, Li₃Na₃₋ₓPS₄). Optionally the anion carrier can be taken to the melting point of at least one of its atomic species (e.g. Li and Na) and optionally plasmonic catalyst materials from literature could be excited.

It is envisioned within the scope of this invention that a synergy between the diverse orthogonal energy stimuli can provide diverse advantages from the material selection as well as the process and/or device design perspective. Thermal limitations of the aforementioned considerations are generally related to diffusion, melting, or evaporation of a component or subcomponent. It is envisionable for those skilled in the art that materials diffusion and reaction are generally dependent on each other, yet in-situ or ex-situ application of at least one of the following: an electric field, a magnetic field, an electromagnetic field (e.g. UV-Vis-IR or microwave), a plasmon, a plasma (e.g. thermal or non-thermal), a chemical potential, ultrasound, and a combination thereof, to name a few, can promote a reaction without significantly altering the diffusion or degradation of a material in relation to the required thermal energy to achieve similar yields.

In the case of plasmonic materials it is believed that the oscillating nature of the created electric fields can temporarily align the band structures as to promote a reaction as if the chosen materials were in proper band alignment as well as hot electrons could promote reactions not typically available at given overall material temperature. Notable high temperature reactions involve the reaction between nitrogen and oxygen to form NOₓ. Furthermore the photonic degradation of a material can induce vacancies in the anion carrier. These phenomena are conventionally termed as photo-bleaching or photo-corrosion, yet from the carrier material perspective it can be appreciated as the regeneration of the material. Hence anybody of ordinary skill in the art could envision without departing from the scope of this disclosure that a highly photo-corroding sulfide material would be beneficial for the regeneration step or in a continuous type of process where the overall sulfur content of the material may be stabilized by the equilibrium of the photo-corrosion or vacancy creation with the concomitant occupation of vacancies with H₂S.

A further non-limiting embodiment relates to the above room temperature decomposition of H₂S utilizing plasmonic materials such as TiNₓ, ZrNₓ, VNₓ or their oxynitrides such as TiNₓO_{y}, ZrNₓO_{y} and VNₓO_{y}, the aforementioned doped with lithium, the aforementioned doped with sulfur, or a combination thereof in order to produce hydrogen, and/or ammonia as well as for the desulfurization or deoxidation of an anion carrier.

Furthermore it could be appreciated by those skilled in the art that a continuous process could be envisioned, particularly when operating near the thermodynamic inflection point from changing from a thermodynamically and/or kinetically preferred anion loading state to another (e.g. MeS_{X} and MeS_{X+1}), that an orthogonal energy input could promote a given reaction with a reduced thermal budget. Such reduced operational temperature window could reduce the energy expenditure of the overall process ensuing sustainability and economic benefits. As a further non-limiting embodiment considers mobile anion carriers being particularly displaced between diverse atmospheres (e.g. nitrogen, reducing, nitrogen and oxidizing) as well as between dark and a photonic stimuli (e.g. to a solar reactor).

A further non-limiting embodiment relates to the use of hydrogen sulfide with open (external) cathode batteries such as a lithium-air, lithium-nitrogen, and a potential lithium-H₂S as well as other metal versions (e.g. Na) of them. Lithium-nitrogen batteries form lithium nitride in the cathode. In order to reverse this process a higher voltage is required than for lithium sulfide, hence reacting that lithium nitride with H₂S could improve the overall charging electric potential requirements of the cell while producing a nitrous stream. The left sulfur can be molten or evaporated and the cell could be used again. In the case of the lithium-air batteries they tend to form lithium oxide species, some of which are considered as irreversible. By exposing such lithium oxide species to H₂S the oxygen release, reaction, or exchange with sulfur would result in a lower charging potential and in select cases as a restoration of capacity.

Throughout the application ordinal numbers (for example, first, second, third) may be used as an adjective for an element (that is, any noun in the application). The use of ordinal numbers does not imply or create a particular ordering of the elements or limit any element to being only a single element unless expressly disclosed, such as by the use of the terms “before,” “after,” “single,” and other such terminology. The use of ordinal numbers is to distinguish between the elements. By way of an example, a first element is distinct from a second element and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a active catalyst” includes references to one or more of such catalyst.

Terms such as “approximately” or “substantially” mean that the recited characteristic, parameter, or value need not be achieved exactly, but that deviation or variations, including, for example, tolerances, measurement error, measurement accuracy limitations and other factors known to those skilled in the art, may occur in amounts that do not preclude the effect the characteristic was intended to provide.

Where a range of values is provided, it is understood that each intervening value, to the millionth of the unit of the lower limit (unless the context clearly dictates otherwise), between the upper and lower limit of the range, and any other stated range. Where the stated range includes one or both of the limits, ranges excluding either or both of those included limits are also included in the disclosure.

It is to be understood that one ore more of the steps shown in the flowcharts may be omitted, repeated or performed in a different order than shown. Accordingly, the scope disclosed should not be considered limited to the specific arrangement of the steps shown in the flowcharts.

Although multiple dependent claims are not introduced, it would be apparent to one of skill in the art that the subject matter of the dependent claims of one or more embodiments may be combined with other dependent claims without departing from the scope or spirit of the present disclosure.

Within the skill of the art are to be included, unless otherwise indicated, techniques of physics, chemistry, engineering, catalysis, material science & engineering, analysis & quantification, economics, and the like. Such techniques are fully explained in the literature.

Although only a few example embodiments have been described in detail above those skilled in the art will readily appreciate that many modifications are possible in the example embodiments without materially departing from this invention. Accordingly, all such modifications are intended to be included within the scope of this disclosure as a defined in the following claims.

The invention claimed is:

1. A method to at least partially desulfurize, nitrogenize or both an atomic hydrogen containing first stream to a first nitrous stream by contacting a first anion carrier with a first stream comprised of at least one of the following: a first sulfurous stream, a first oxidic stream, and a combination thereof, hence producing a second anion carrier and the first nitrous stream, wherein a sulfurous stream comprises hydrogen sulfide and at least one of the following: nitrogen, hydrogen, carbon monoxide, carbon dioxide, methane, ethane, propane, hydrocarbons, noble gas, the like, and a mixture thereof, wherein an oxidic stream includes at least one of the following: water, steam, hydrogen peroxide, oxygen, ozone, oxide ion, air, CO₂, CO, and a combination thereof, wherein a nitrous stream comprises at least one of the following: ammonia, nitric acid, N₂O, NO, NO₂, NO₃, cyanamide, thiourea, urea, ammonium nitrate, nitrogen, the like, and a combination thereof, wherein the anion carrier of variable stoichiometry comprises an overall stoichiometry with at least the following combination of anions: sulfur, oxygen, and nitrogen in individual concentration ranges approximately between 50 ppt and approximately 99.9999999%, wherein the anion carrier comprises at least one of: an ionic carrier material, a composite ionic carrier material, a carrier material support, a catalyst, a catalyst support, a phosphorous containing carrier material, and a combination thereof;
regenerating the second anion carrier approximately to the stoichiometry of the first anion carrier by providing or withdrawing at least once one of the following: a second nitrous stream, a second oxidic stream, helium, argon, vacuum, a second sulfurous stream further comprising: sulfur, sulfur oxide, sulfur dioxide, sulfur trioxide, sulfurous acid, sulfuric acid, and a combination thereof.

2. A method of claim 1, wherein at least one of the following: absorption, adsorption, desorption, diffusion, regeneration, exsolution, intercalation, reaction, plasmonic excitation and combinations thereof of the ionic, neutral species or both related to the carrier material is promoted by the synergy of at least two of the following: a thermal stimuli, wherein temperature ranges between −20° C. to 1100° C.; an electric stimuli, wherein the applied potential ranges between −15V to 15V, whether in constant potential (DC), alternating potential (AC) with frequency between 0.001 Hz and 1000 PHz, pulsed potential, the like, and a combination thereof; a photonic stimuli, wherein at least a photon has a wavelength between 200 nm and 10000 nm; a chemical potential stimuli, wherein chemical species surrounding the anion carrier are with a partial pressure of at least one of the following species: oxidic, sulfurous, nitrous, inert gases and a combination thereof ranges within 10⁻⁹ to 10⁴ atm; an acoustic stimuli wherein an excitation frequency lies within 1 kHz and 1 MHz.

3. The method of claim 2, wherein at least one ionic species comprised of at least one of the following atomic species: Li, Na, Mn, Mg, Ca, Zn, Al, O, S, N, and combinations thereof, is diffused to, diffused from, or both, the superficial layer of the anion carrier for at least one of the following steps: nitrogenization of an anion carrier, oxidation of an anion carrier, desulfurization of an anion carrier, deoxidization of the anion carrier, denitrogenization of an anion carrier, contacting an anion carrier with the sulfurous stream, contacting an anion carrier with an oxidic stream, contacting an anion carrier with a nitrous stream, producing a nitrous stream, desulfurizing a fluid stream, the like, and a combination thereof.

4. A method of claim 3, wherein to nitrogenize an anion carrier of variable stoichiometry, a nitrous stream comprised of nitrogen is used as the nitrogen source; one ionic species from the nitrogenized superficial layer is at least partially diffused to the bulk layer of an ionic conductor, wherein the ionic species is comprised of at least one of the following: Li, Mn, Mg, Na, K, Zn, Fc, Al and a combination thereof, while at least once providing concomitantly, sequentially, or both an oxidic stream, wherein the oxidic stream includes at least one of the following: water, hydrogen peroxide, oxygen, ozone, CO, CO₂, oxide ion, and a combination thereof;
and at least performing one of the following steps in any order: provide an ammonia containing stream; provide a sulfurous stream; additional ionic species being diffused to, from, or both the superficial layer of the anion carrier, produce as fluid or bound species at least one of the following species, their precursors or both: nitric acid, N₂O, NO, NO₂, NO₃, cyanamide, thiourea, urea; and a combination thereof.

5. A method of claim 4, wherein a diffused material is molten or taken near to its melting point.

6. The method of claim 2, wherein at least one of: the anion carrier, anion carrier support, the catalyst, catalyst support and combinations thereof, is further comprised of at least one of the following: Li, Mn, Mg, Ca, Ce, Bi, Zr, Al, V, Zn, Co, Cu, Ni, In, as in the non-limiting combinations of anion carriers or composite anion carriers comprising an overall composition of: Ce_{α}Mn_{β}OₓS_{y}N_{z}, Ce_{α}Au_{β}OₓS_{y}N_{z}, Ce_{α}Pt_{β}OₓS_{y}N_{z}, Ce_{α}Li_{β}OₓS_{y}N_{z}, Ce_{α}Li_{β}Mn_{γ}OₓS_{y}N_{z}, Co_{α}Li_{β}Mn_{γ}Bi_{δ}OₓS_{y}N_{z}, Ce_{α}Li_{β}Mn_{γ}Bi_{δ}Au_{ε}OₓS_{y}N_{z}, Ce_{α}Li_{β}Mn_{γ}Bi_{δ}Pt_{ε}OₓS_{y}N_{z}, Ce_{α}Li_{β}Mn_{γ}Bi_{δ}Ag_{ε}OₓS_{y}N_{z} the aforementioned doped with Gd or Sm, Li_{α}Mo_{β}OₓS_{y}N_{z}, Mn_{α}Mo_{β}OₓS_{y}N_{z} Li_{α}NaβOₓS_{y}N_{z}, Li_{α}Na_{β}P_{γ}SₓO_{y}N_{z}, Li_{α}Ge_{β}P_{γ}OₓS_{y}N_{z}, Li_{α}Na_{β}P_{γ}OₓS_{y}N_{z}, Li_{α}Si_{β}P_{γ}OₓS_{y}N_{z}, Li_{α}Na_{β}Sr_{γ}Zr_{δ}P_{ε}OₓS_{y}N_{z}, Li_{α}Na_{β}Mn_{γ}Mg_{δ}Zn_{ε}P_{w}OₓS_{y}A_{z}, Li_{α}Si_{β}P_{γ}A_{δ}OₓS_{y}N_{z}, Li_{α}La_{β}Zr_{γ}OₓS_{y}N_{z}, Li_{α}La_{β}Ce_{γ}OₓS_{y}N_{z}, Li_{α}Na_{β}Zr_{γ}P_{δ}OₓS_{y}N_{z}, Li_{α}Ce_{β}P_{γ}OₓS_{y}N_{z}, CaOₓS_{y}N_{z}, AgLiOₓS_{y}N, MnOₓS_{y}N_{z}, MgOₓS_{y}N_{z}, ZnOₓS_{y}N_{z}, Li_{α}Y_{β}Zr_{γ}OₓS_{y}N_{z}, Mn_{α}Y_{β}Zr_{γ}OₓS_{y}N_{z}, Mg_{α}Y_{β}Zr_{γ}OₓS_{y}N_{z}, Ca_{α}Y_{β}Zr_{γ}OₓS_{y}N_{z}, Li_{α}V_{β}OₓS_{y}N_{z}, La_{α}Sr_{β}V_{γ}OₓS_{y}N_{z}, Gd_{α}Ti_{β}Mo_{γ}OₓS_{y}N_{z}, Bi_{α}Me_{β}V_{γ}OₓS_{y}N_{z}, Dy_{α}Gd_{β}Bi_{γ}Li_{δ}OₓS_{y}N_{z}, Dy_{α}Gd_{β}Bi_{γ}Mn_{δ}OₓS_{y}N_{z}, Dy_{α}Gd_{β}Bi_{γ}Mg_{δ}OₓS_{y}N_{z}, Dy_{α}Gd_{β}Bi_{γ}Ca_{δ}OₓS_{y}N_{z}, BaZrYOₓS_{y}N_{z}, BaCeYOₓS_{y}N_{z}, Co_{α}Ni_{β}Zn_{γ}In_{δ}OₓS_{y}N_{z}, Li_{α}Na_{β}Me_{γ}Te_{δ}OₓS_{y}N_{z}, Me, Me exsolutions, MeOₓS_{y}N_{z} exsolutions, solutions thereof, the aforementioned carbon allotrope coated (e.g. graphene) coated, the aforementioned carbon allotrope encapsulated, and combinations thereof, wherein α+β+γ+δ+ε=1 and x+y+3/2z ranges between 0.00 and 3, Me is comprised of at least one of the following: a transition metal (e.g. including but not limited to: Mn, Au, Ag, Rh, Ir, Re, Ni, Co, Zn, Ta, Nb), Li, Ca, Mg, Sr, Ba, Na, K, Nd, a lanthanide (e.g. including but not limited to: Ce, Sm, Dy, Er, La, Pr, to name a few) or combinations thereof, and A is a halide (e.g. Cl, I, F).

7. An apparatus to at least partially desulfurize an H₂S containing stream and produce a effluent stream comprised of at least the following layers, elements, or both: anion carrier, electrodes, and an ionic conductive material, wherein the effluent stream comprises at least one of the following: ammonia, hydrogen, nitric acid, N₂O, NO, NO₂, NO₃, cyanamide, thiourea, urea, ammonium nitrate, nitrogen, the like, and a combination thereof; the apparatus further comprising at least one of the following layers, elements, or both: catalyst, catalyst support, carrier support, mechanical support, photon transparent window, heat exchanger, inlet, outlet, enclosure, porous superficial layer, carbon allotrope encapsulated electrode, sulfur remover, sulfur collector, a solar receiver, a solar concentrator, the like, and combinations thereof.

8. An apparatus of claim 7, wherein materials for the ionic conductor can conduct at least one of the following species through its bulk: Li, Na, Mn, Mg, K, Zn, Fe, Al, Ce, Ni, Cu, Sn, Ga, O, N, S, Cl, I, F, and a combination thereof.

9. A method of claim 2, wherein hydrogen, ammonia or both are produced at least partially from an oxidic stream, where an anion carrier comprised of sulfur and oxygen anions, or sulfur, oxygen and nitrogen anions is oxidized, and subsequently the anion carrier is sulfurized in order to reduce the energy input of at least one of the following steps performed on the anion carrier: regeneration, nitrogenization, deoxidization, desulfurization, reduction, and combinations thereof, wherein energy input comprises at least one of: thermal, electrical, photonic, chemical potential, ultrasonic, the like, and a combination thereof.

10. A method of claim 2, wherein hydrogen, ammonia or both are produced at least partially from an sulfur containing fluid (e.g. H₂S), where the anion carrier is comprised of sulfur and oxygen anions, or sulfur, oxygen and nitrogen anions is sulfurized, and subsequently the anion carrier is oxidized in order to reduce the energy input of at least one of the following steps performed on the anion carrier: the regeneration, the nitrogenization, deoxidization, desulfurization, diffusion to the support material, and combinations thereof, wherein energy input comprises at least one of: thermal, electrical, photonic, chemical potential, ultrasonic, the like, and a combination thereof.

11. A method of claim 10, where the material includes at least one of the following: Au, Ag, Pt, Rh, Ir and Re and optionally at least one of the following: alloying them with at least one of the following: Li, Na, Mn, Mg, Ca, Al, Zn and combinations thereof; supporting them on at least one of the following: ceria, zirconia, bismuth oxide, zeolite, the aforementioned doped with a transition metal (e.g. Y, Sc, V), a lanthanide (e.g. Gd, Sm, Dy, Er), an actinide (e.g. Th) and a combination thereof.

12. A method of claim 2, wherein a plasmonic catalyst material is comprised at least of one of the following: TiNₓ·ZrNₓ, VNₓ, HfNₓ, TaNₓ, MoNₓ, CrNₓ, NbNₓ, TiNₓO_{y}, ZrNₓO_{y}, VNₓO_{y}, HfNₓO_{y}, TaNₓO_{y}, MoNₓO_{y}, CrNₓO_{y}, NbNₓO_{y}, the aforementioned doped with at least one of the following lithium, sulfur, manganese, magnesium ceria, calcium, sodium, potassium, barium, strontium, lanthanum, cobalt, or a combination thereof, wherein x+y ranges between 0.2 and 3 is used in order to perform at least one of the following: produce hydrogen, produce a nitrous stream, desulfurize a carrier material, deoxidize a carrier material, nitrogenize a carrier material, oxidize a carrier material, nitrogenize a fluid stream, oxidize a fluid stream, and a combination thereof.

13. A method, wherein during the charging or discharge cycle of an electrochemical cell, H₂S is provided to an electrode in order to at least one of the following: reduce the energy input, increase the throughput, restore capacity, produce ammonia, and a combination thereof, of at least one of the following: a metal-air battery, a metal-nitrogen battery, a metal-H₂S battery, or a combination thereof, wherein the ionic species comprises at least one of the following species: Li, Na, Mn, Mg, K, Zn, Fe, Al, OH, H and a combination thereof, wherein the electrode is comprised at least partially of one of the aforementioned species, their oxides, their sulfides, their nitrides, their oxynitrides, their oxysulfides, their sulfinitrides, their sulfoxynitrides, and combinations thereof.

14. A method where sodium, lithium, or both are diffused, displaced or both at least partially by an electro-chemical potential from a carrier material to a first superficial layer, fluid layer, or both wherein the first layer is further comprised of a catalyst including at least one of the following: Na, Li, Mn, Ru, Ag, Au, In, Mg, Ta, Nb, Co, Ni, Cu, V, Nd, H, C allotrope including graphene, La, a transition metal, the nitrides thereof, the oxides thereof, the sulfides thereof, the nitrites thereof, the nitrates thereof, the like, and combinations thereof, and reacted with nitrogen to form a second superficial layer, fluid layer, or both comprised at least of one of: sodium, lithium nitride, sodium lithium nitride, and a combination thereof, wherein the diffusion, the reaction, or both are carried at a temperature between 0° C. and 600° C.;
and at least performing one of the following steps in any order:
at least partially reabsorbing lithium, sodium or both into the carrier material from the second superficial layer, fluid layer or both;
reacting the second superficial layer, fluid layer, or both with an oxidic stream comprised of at least of one of the following: oxygen, air, ozone, CO, CO₂, water and a combination thereof, to form third superficial layer, fluid layer or both comprised of at least nitrogen and oxygen containing species including at least one of the following: hyponitrites, oxohyponitrite, nitrite, nitrate, nitrous oxides, the like, and combinations thereof;
at least partially reabsorbing lithium, sodium, or both into the carrier material from at least one of the following: the second superficial layer, third superficial layer, an intermediate superficial layer, fluid layer and a combination thereof;
reacting the surface with ammonia;
produce nitrous species as a fluid or bound species comprised of at least one of the following: nitric acid, N₂O, NO, NO₂, NO₃, cyanamide, thiourea, urea, ammonium nitrate, and combinations thereof;
and a combination of steps.

15. A method of claim 14, wherein at least one of the following: absorption, adsorption, desorption, diffusion, regeneration, exsolution, intercalation, reaction, plasmonic excitation and combinations thereof of the ionic, neutral species or both related to the carrier material is promoted by the synergy of at least two of the following: a thermal stimuli, wherein temperature ranges between −20° C. to 1100° C.; an electric stimuli, wherein the applied potential ranges between −15V to 15V, whether in constant potential (DC), alternating potential (AC) with frequency between 0.001 Hz and 1000 PHz, pulsed potential, the like, and a combination thereof; a photonic stimuli, wherein at least a photon has a wavelength between 200 nm and 10000 nm; a chemical potential stimuli, wherein chemical species surrounding the anion carrier are with a partial pressure of at least one of the following species: oxidic, sulfurous, nitrous, inert gases and a combination thereof ranges within 10⁻⁹ to 10⁴ atm; an acoustic stimuli wherein an excitation frequency lies within 1 kHz and 1 MHz.

16. A method of claim 14, wherein the carrier material is comprised at least of one of the following: La_{α}Co_{β}Mn_{γ}Ni_{δ}OₓS_{y}N_{z}, Co_{α}Ni_{β}Zn_{γ}In_{δ}OₓS_{y}N_{z}, Li_{α}Na_{β}Zr_{γ}P_{δ}OₓS_{y}N_{z}, Li_{α}Na_{β}Zr_{γ}Si_{ε}P_{δ}OₓS_{y}N_{z}, Li_{α}Na_{β}Zr_{γ}Ge_{ε}P_{δ}OₓS_{y}N_{z}, Ta_{α}Nb_{β}OₓS_{y}N_{z}, Nd_{α}OₓS_{y}N_{z}, Li_{α}Na_{β}P_{γ}OₓS_{y}N_{z}, Na_{α}M_{β}Te_{γ}OₓS_{y}N_{z}, M, MOₓS_{y}N_{z} exsolution, M exsolution and a combination thereof, wherein α+β+γ+δ+ε=1 and x+y+3/2z ranges between 0.00 and 3, wherein M is comprised of at least one of the following: Li, Na, Ta, Co, Ni, Zn, Mg Ag, Pt, Pd, or a combination thereof.
